(19) United States
(12) Patent Application Publication
(10) Pub. No.: US 2010/0243903 A1
(43) Pub. Date: Sep. 30, 2010

(54) METHOD AND SYSTEM FOR MATERIAL CHARACTERIZATION IN SEMICONDUCTOR PRODUCTION PROCESSES BASED ON FTIR WITH VARIABLE ANGLE OF INCIDENCE

(76) Inventors: Torsten Fahr, Dresden (DE); Matthias Schaller, Moritzburg (DE); Wolfgang Buchholtz, Radebeul (DE)

Correspondence Address: WILLIAMS, MORGAN & AMERSON, 10333 RICHMOND, SUITE 1100, HOUSTON, TX, 77042, US

(21) Appl. No.: 12/728,582

(22) Filed: Mar. 22, 2010

(30) Foreign Application Priority Data
Mar. 31, 2009 (DE) 10 2009 015 746.8

(51) Int. Cl. G01N 21/27; G01N 21/84

(52) U.S. Cl. 250/339.08; 250/339.07

(57) ABSTRACT

During the processing of complex semiconductor devices, dielectric material systems comprising a patterned structure may be analyzed in a non-destructive manner by using an FTIR technique in combination with a plurality of angles of incidence. In this manner, topography-related information may be obtained and/or data analysis may be made more efficient due to the increased amount of information obtained by the plurality of angles of incidence.

### BACKGROUND OF THE INVENTION

1. Field of the Invention

The present disclosure generally relates to the field of fabricating semiconductor devices, and, more particularly, to process control and monitoring techniques for manufacturing processes on the basis of optical measurement strategies.

2. Description of the Related Art

Today's global market forces manufacturers of mass products to offer high quality products at a low price. It is thus important to improve yield and process efficiency to minimize production costs. This holds especially true in the field of semiconductor fabrication, since, here, it is essential to combine cutting edge technology with volume production techniques. It is, therefore, the goal of semiconductor manufacturers to reduce the consumption of raw materials and consumables while at the same time improve product quality and process tool utilization. For example, in manufacturing modern integrated circuits, several hundred individual processes may be necessary to complete the integrated circuit, wherein failure in a single process step may result in a loss of the complete integrated circuit. This problem is even exacerbated in current developments striving to increase the size of substrates, on which a moderately high number of such integrated circuits are commonly processed, so that failure in a single process step may possibly entail the loss of a large number of products.

Therefore, the various manufacturing stages have to be thoroughly monitored to avoid undue waste of manpower, tool operation time and raw materials. Ideally, the effect of each individual process step on each substrate would be detected by measurement and the substrate under consideration would be released for further processing only if the required specifications, which would desirably have well-understood correlations to the final product quality, were met. A corresponding process control, however, is not practical, since measuring the effects of certain processes may require relatively long measurement times, frequently ex situ, or may even necessitate the destruction of the sample. Moreover, immense effort, in terms of time and equipment, would have to be made on the metrology side to provide the required measurement results. Additionally, utilization of the process tool would be minimized since the tool would be released only after the provision of the measurement result and its assessment. Furthermore, many of the complex mutual dependencies of the various processes are typically not known, so that an a priori determination of respective “optimum” process specifications may be difficult.

The introduction of statistical methods, also referred to as statistical process control (SPC), for adjusting process parameters significantly relaxes the above problem and allows a moderate utilization of the process tools while attaining a relatively high product yield. Statistical process control is based on the monitoring of the process output to thereby identify an out-of-control situation, wherein a causality relationship may be established to an external disturbance. After occurrence of an out-of-control situation, operator interaction is usually required to manipulate a process parameter to return to an in-control situation, wherein the causality relationship may be helpful in selecting an appropriate control action. Nevertheless, in total, a large number of dummy substrates or pilot substrates may be necessary to adjust process parameters of respective process tools, wherein tolerable parameter drifts during the process have to be taken into consideration when designing a process sequence, since such parameter drifts may remain undetected over a long time period or may not be efficiently compensated for by SPC techniques.

Recently, a process control strategy has been introduced, and is continuously being improved, allowing enhanced efficiency of process control, desirably on a run-to-run basis, while requiring only a moderate amount of a measurement data. In this control strategy, the so-called advanced process control (APC), a model of a process or of a group of interrelated processes, is established and implemented in an appropriately configured process controller. The process controller also receives information, including pre-process measurement data and/or post-process measurement data, as well as information related, for instance, to the substrate history, such as type of process or processes, the product type, the process tool or process tools in which the products are to be processed or have been processed in previous steps, the process recipe to be used, i.e., a set of required sub steps for the process or processes under consideration, wherein possibly fixed process parameters and variable process parameters may be contained, and the like. From this information and the process model, the process controller determines a controller state or process state that describes the effect of the process or processes under consideration on the specific product, thereby permitting the establishment of an appropriate parameter setting of the variable parameters of the specified process recipe to be performed with the substrate under consideration.

Although significant advances in providing enhanced process control strategies have been made, process variations may nevertheless occur during the complex interrelated manufacturing sequences which may be caused by the plurality of individual process steps, which may affect the various materials in a more or less pronounced manner. These mutual influences may finally result in a significant variability of material characteristics, which in turn may then have a significant influence on the final electrical performance of the semiconductor device under consideration. Due to the continuous shrinkage of critical feature sizes, at least in some stages of the overall manufacturing process, frequently new materials may have to be introduced so as to adapt device characteristics to the reduced feature sizes. One prominent example in this respect is the fabrication of sophisticated metallization systems of semiconductor devices in which advanced metal materials, such as copper, copper alloys and the like, are used in combination with low-k dielectric materials, which are to be understood as dielectric materials having a dielectric constant of approximately 3.0 and significantly less, in which case these materials may also be referred to as ultra low-k dielectrics (ULK). By using highly conductive metals, such as copper, the reduced cross-sectional area of metal lines and vias may at least be partially compensated for by the increased conductivity of copper compared to, for instance, aluminum, which has been the metal of choice over the last decades, even for sophisticated integrated devices. On the other hand, the introduction of copper into semiconductor manufacturing strategies may be associated with a plurality of problems, such as high sensitivity of exposed copper surfaces with respect to reactive components, such as oxygen, fluorine and the like, the increased diffusion activity of copper in a plurality of materials typically used in semiconductor devices, such as silicon, silicon dioxide, a plurality of low-k dielectric materials and the like, copper's characteristic of generating substantially no volatile byproducts on the basis of typically used plasma enhanced etch processes and the like. For these reasons, sophisticated inlaid or damascene process techniques have been developed in which, typically, the dielectric material may have to be patterned first in order to create trenches and via openings, which may then be coated by an appropriate barrier material followed by the deposition of the copper material. Consequently, a plurality of highly complex processes, such as the deposition of sophisticated material stacks for forming the interlayer dielectric material including low-k dielectrics, patterning the dielectric material, providing appropriate barrier and seed materials, filling in the copper material, removing any excess material and the like, may be required for forming sophisticated metallization systems wherein the mutual interactions of these processes may be difficult to assess, in particular, as material compositions and process strategies may frequently change in view of further enhancing overall performance of the semiconductor devices. Consequently, a thorough monitoring of the material characteristics may be required during the entire manufacturing sequence for forming sophisticated metallization systems in order to efficiently identify process variations, which may typically remain undetected despite the provision of sophisticated controlling and monitoring strategies, as described above.

With reference to FIGS. 1a-1b, typical process strategies of monitoring the characteristics of dielectric materials may be described in accordance with typical conventional process strategies.

FIG. 1a schematically illustrates a semiconductor device 100 in a manufacturing stage in which one or more material layers 110 are formed above a substrate 101. It should be appreciated that the substrate 101 may represent any appropriate carrier material for forming thereon and therein respective circuit elements, such as transistors, capacitors and the like, as may be required by the overall configuration of the device 100. The one or more material layers 110 may be formed at any appropriate manufacturing stage, for instance, during a sequence for forming circuit elements in the device layer, i.e., in and above a semiconductor layer (not shown), or may be formed in the contact level or metallization level of the device 100. In the example shown in FIG. 1a, it may be assumed that the one or more material layers 110 may comprise a plurality of dielectric materials 110A, 110B, 110C which may, for instance, represent a complex material system as may, for instance, be required for forming respective circuit elements or any other device features. For example, the dielectric layer 110A may represent a material, such as silicon dioxide, polycrystalline silicon and the like, which may be patterned on the basis of the layers 110B, 110C, which may represent an anti-reflective coating (ARC) layer and a photoresist material, respectively, and the like. Thus, the material composition of the individual layers 110A, 110B, 110C may have a significant influence during the further processing of the device 100 and on the finally obtained electrical performance of the device 100. For instance, the material composition of the individual layers 110B, 110C may significantly affect the behavior during the lithography process for patterning the layer 110A. For instance, the index of refraction and the absorbance of the layers 110C, 110B and 110A with respect to an exposure wavelength may result in a certain optical response of the layers 110, which may be adjusted on the basis of the layer thickness of the individual layers 110. Consequently, during the deposition of the layers 110A, 110B, 110C, a respective process control may be applied to reduce process variations, which may result in an undesired variation of the material composition, while the thickness of individual layers 110A, 110B, 110C may also be controlled in order to maintain overall process quality. For this purpose, non-destructive optical measurement techniques are available, such as ellipsometry and the like, in which the optical thickness of the individual layers 110C, 110B, 110A may be determined, possibly after each deposition step, by using an appropriate probing optical beam 102A, which may contain any appropriate wavelength, and detecting a reflected or refracted beam 102B. Consequently, by the optical measurement process based on the beams 102A, 102B, inline measurement data may be provided to enhance process control for forming the dielectric layers 110. However, the conventionally applied optical measurement techniques may provide information about material characteristics which may vary in a more or less step-like manner, such as a pronounced change of the index of refraction at interfaces between the various layers 110A, 110B, 110C, which may be very convenient in determining the optical thickness of the materials 110 but which may not provide information with respect to a more or less gradually varying material characteristic of one or more of the layers 110. For example, it may be very difficult to determine a gradual variation within one of the layers 110 in different semiconductor devices or device areas on the basis of conventionally applied optical measurement techniques.

FIG. 1b schematically illustrates the semiconductor device 100 according to a further example, in which the plurality of dielectric materials 110 may represent one or more materials of an interlayer dielectric material of a metallization system 120. For example, the layers 110 may comprise a dielectric material 110E, which may be provided in the form of a low-k dielectric material, a “conventional” dielectric material such as fluorine-doped silicon dioxide and the like, while a further dielectric material 110D may represent a low-k dielectric material, which may differ in composition from the layer 110E or which may represent substantially the same material, depending on the overall process strategy. Furthermore, as previously explained, a trench 110F may be formed in the layer 110D and a via opening 110G may be provided in the dielectric material 110E. Furthermore, in the manufacturing stage shown, a barrier layer 121 may be formed on exposed surface portions of layers 110D, 110E. For instance, the barrier layer 121 may be comprised of tantalum, tantalum nitride and the like, which are frequently used barrier materials in combination with copper.

The semiconductor device 100 as shown in FIG. 1b may be formed in accordance with well-established damascene strategies in which the layers 110E, 110D, possibly in combination with an etch stop layer 111, may be deposited by any appropriate deposition technique. During the corresponding process sequence for forming the layers 110E, 110D, optical measurement techniques may be used, for instance on the basis of the above-described concepts, in order to provide measurement data for controlling layer thickness and the like. Thereafter, the openings 110F, 110G may be formed by appropriate patterning regimes, which may involve lithography processes, resist removal processes, etch steps, cleaning steps and the like, thereby resulting in a more or less pronounced exposure of the layers 110D, 110E to various process conditions, which may have an influence on at least exposed portions of the materials 110E, 110D. For example, low-k dielectrics and in particular ultra low-k dielectric materials may be sensitive to a plurality of chemical components, which may typically be applied during the various processes, such as resist removal processes, etch processes, cleaning processes and the like. Consequently, a certain degree of material modification or damaging may occur in the layer 110D and/or the layer 110E, depending on the overall process strategy. Consequently, during the further processing, for instance by providing the barrier layer 121, the modified material composition in the dielectric material 110 may result in different process conditions and possibly also in different material characteristics of the barrier layer 121, thereby also affecting the further processing. For example, the material modification or damaging of the layer 110D may result in a reduced adhesion and/or diffusion blocking effect of the barrier material 121, which may compromise the overall reliability of the metallization system 120. In other cases, during the removal of excess material of the copper and the barrier material 121 after the electrochemical deposition of the copper material, the damaged areas of the layer 110D may have an influence on the removal conditions, which in turn may also negatively affect the overall characteristics of the resulting metallization system 120.

It is thus important to monitor respective material modifications during the process sequence for forming the metallization system 120 which, however, may be very difficult on the basis of optical inline measurement techniques as may be used for determining characteristics such as layer thickness and the like, as previously explained with reference to FIG. 1a. The situation becomes even more complex when the material modification is to be determined for patterned devices since the patterning processes, as well as the geometry of the feature elements to be formed in the layers 110, may also affect the degree of material modification, since, during the patterning process, a plurality of additional process conditions may be “seen” by the materials 110, which may result in a different degree of material modification compared to non-patterned structures. Since the degree of material modification may gradually vary due to even minor process variations during the complex sequence of manufacturing processes involved, in particular in patterned device structures, it may be extremely difficult to obtain a quantitative measure of the degree of damage on the basis of optical measurement techniques used in a conventional context. For this reason, frequently, external measurement techniques may be used, which may typically involve destructive analysis techniques, such as cross-sectional analysis by electron microscopy and the like, in order to obtain information on the degree of material modification within the material layers 110. However, due to the destructive nature of the analysis techniques involved, only a very limited amount of measurement data may be gathered, thereby contributing to a less efficient overall process control. Furthermore, due to the external analysis technique including sophisticated sample preparation and the like, a significant amount of delay may be involved in obtaining the measurement data, thereby also contributing to a less efficient control mechanism for the manufacturing sequence for forming the metallization system 120.

For this reason, it has also been proposed to use non-destructive analysis methods in which the structural characteristics of materials, i.e., the individual atomic species and their chemical bonds to each other, may be analyzed on the basis of infrared radiation which may have an appropriate wavelength range for exciting oscillations and/or rotations of the chemical bonds in the materials under interest. As is well known, the electronic bonds between individual species of a molecular or crystal structure may have different energy levels, wherein rotational degrees of freedom and vibrations may have an energy level within the energy corresponding to infrared wavelength. Consequently, by irradiating infrared radiation into a material having a molecular structure in which the corresponding excited states may have an appropriate energy level without significantly absorbing energy by the individual electronic states of atoms or crystals, an increased absorption may be observed in the initial infrared radiation, which may be efficiently analyzed with respect to the type of atomic species, the type of chemical bondings and the like, wherein a moderately accurate quantitative estimation may also be obtained. Consequently, infrared spectroscopy represents an efficient analysis technique for dielectric materials which may typically have absorption behavior in which energy levels of rotational and vibrational excited states are sufficiently different from a band gap energy or the electronic excited states of the individual atoms so that absorption is primarily determined by the chemical characteristics of interest. Thus, the absorption behavior for a plurality of wavelengths may be observed in the form of a spectrum, which may then be analyzed in a quantitative and qualitative manner. For this purpose, Fourier transformed infrared spectroscopy has been proven as a viable technique to obtain meaningful measurement data with a reduced measurement time with a moderately high signal-to-noise ratio. The Fourier transformed infrared spectroscopy (FTIR) is a measurement technique in which a specific range of infrared wavelengths is simultaneously provided in a probing beam so as to obtain a response of the material of interest for a plurality of different wavelengths within a very limited time interval. For this purpose, an infrared radiation is first modulated by appropriately varying the optical path length of a first part of the initial infrared radiation, while another part thereof may remain unmodified. For example, initial infrared radiation may be directed on a beam splitter, wherein one optical path may comprise a movable mirror, or any other means so as to gradually change the effective optical path length of this part of the infrared radiation. Thus, after again passing through the beam splitter, a modulated combined infrared beam is obtained, in which the interference obtained for the various wavelengths on the basis of the moving mirror may result in an overall modulation, thereby obtaining the desired probing beam, which may also be referred to as an interferogram. This combined wavelength or interferogram may then be directed to the material of interest, which may thus interact with the plurality of different wavelengths simultaneously and a corresponding response, i.e., the wavelength-dependent absorption of the initial probing beam, may be detected by any appropriate detector. Due to the specific interference modulation of the probing beam, it has the characteristic that may be readily transformed or calculated into a spectrum, i.e., into a representation of wavelength or wave number versus intensity so that the initial information in the probing beam as well as any response thereto may be provided in the form of measurement spectra, in which a specific absorbance may be efficiently used for identifying the type and amount of corresponding atomic species, characteristic chemical bonds and the like. Consequently, since the time interval required for the modulation of the initial infrared radiation is moderately small, since only minimal physical displacements of a corresponding mirror are required, the required measurement times are also small, wherein the availability of an entire wavelength range and overall small measurement time may result in a high signal-to-noise ratio compared to other measurement techniques in which a specific wavelength range may have to be scanned. Consequently, upon directing the modulated infrared beam onto a sample, such as a material system of a semiconductor device, the resulting interferogram comprises the desired information with respect to one or more material characteristics due to the corresponding absorbance that is determined by the present status of the materials, as explained above. The corresponding interferogram of the optical response is efficiently converted into a spectrum by a Fourier transformation, wherein the corresponding spectrum may then be used for further data analysis in order to extract the desired information and obtain a value for quantitatively characterizing the material characteristic under consideration, for instance a degree of modification of a sensitive dielectric material and the like. In this manner, the well known inherent advantages of FTIR techniques may be exploited, wherein a desired high fraction of the total energy of the initial infrared radiation is continuously used for probing the sample under consideration, such as the material system of a semiconductor device.

FIG. 1c schematically illustrates the semiconductor device 100 during an FTIR measurement process. As illustrated, the semiconductor device 100 comprises the material layers 110D, 110E in a patterned form, wherein a certain degree of surface modification may have been created during the preceding manufacturing processes, as previously explained. In this manufacturing stage, the material 110D, 110E may be exposed by a probing beam 130A, which may represent an interferogram, i.e., a plurality of wavelengths with an intrinsic interference modulation, as explained above, wherein the corresponding beam 130A is incident on the layers 110D, 110E with a predetermined angle of incidence a. In the embodiment shown, it is assumed that the substrate 101, or at least a surface thereof, is highly reflective so that a substantial portion of the incident beam 130A is reflected in the form of a beam 130B. As previously explained, the beam 130A may comprise an appropriate wavelength range in the infrared area so as to excite the chemical bondings of materials, which may thus result in a wavelength-dependent absorption so that the reflective beam 130B may contain the corresponding information which, upon detection, may be efficiently Fourier transformed into a spectrum 130C. Based on appropriate reference data, such as a spectrum obtained on the basis of the layers 110D, 110E without damaging and the like, certain material characteristics may be evaluated, for instance a thickness of a modified zone and the like. Typically, the wavelengths of the beams 130A, 130B may be greater than the lateral dimensions of device features such as the openings 110F, 110G so that an “integral” evaluation of one or more material characteristics may be obtained, irrespective of the type of patterning of the material under consideration.

Although FTIR provides an efficient tool for detecting gradually varying material characteristics, any topography-related information may be lost due to the moderately long wavelengths used in the probing infrared beam. In view of this situation, the present disclosure relates to techniques and systems in which efficient non-destructive measurement techniques on the basis of FTIR may be used while enhancing the efficiency of information extraction from corresponding measurement spectra while avoiding, or at least reducing, one or more of the problems identified above.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

Generally, the present disclosure provides techniques and systems in which the FTIR measurement technique may be applied on the basis of varying angles of incidence in order to obtain further topography-related information and/or enhance efficiency of extraction of information on material characteristics. That is, non-destructive measurement techniques on the basis of FTIR may be applied to semiconductor devices, i.e., to dielectric material or material systems, which may typically have topography-related characteristics after sophisticated patterning sequences. Consequently, by using two or more angles of incidence, topography-related information may be obtained, for instance when dimensions of device features are comparable with the magnitude of at least some wavelength components used in the probing infrared beam, while, in other cases, the “integral” response of a patterned structure with critical dimensions well below the wavelength of any components in the probing beam may differ due to varying boundary conditions and the like for the different angles of incidence, which may result in a different variability of at least portions of the measurement spectra with respect to a material characteristic of interest. For instance, by determining an appropriate angle of incidence providing the maximum variability with respect to a material characteristic of interest, an enhanced sensitivity may be achieved by selecting the associated angle of incidence, which provides the most efficient overall measurement conditions. In other cases, even a certain degree of topography-related information may be obtained for a device structure in which critical dimensions may be at or slightly below the smallest wavelength component used in the probing beam by “increasing” the effective optical length on the basis of the angle of incidence, thereby “shifting” the structure under consideration into a range which may be comparable or greater than at least some wavelength components. Consequently, in this case, a certain degree of spatial resolution may be achieved, at least for the shortest wavelength components in the spectrum. In other cases, when a significant part of the probing beam has a wavelength that is comparable or greater than topography-related dimensions, an efficient evaluation of topography-related characteristics may be obtained by using different angles of incidence.

One illustrative method disclosed herein comprises obtaining a first measurement data set by performing a first run of a Fourier transformed infrared spectroscopy (FTIR) measurement using a first probing beam directed on a substrate under a first angle of incidence, wherein the substrate comprises a material layer used for forming a microstructure device. The method further comprises obtaining a second measurement data set from the substrate by performing a second run of the FTIR measurement using a second probing beam directed on the substrate under a second angle of incidence that differs from the first angle of incidence. Finally, the method comprises determining at least one structural characteristic of the material layer on the basis of the first and second measurement data sets.

A further illustrative method disclosed herein relates to the monitoring of a material characteristic of one or more material layers in a semiconductor manufacturing process sequence. The method comprises probing the one or more material layers with an infrared beam at a plurality of angles of incidence wherein the infrared beam includes a plurality of wavelengths. The method further comprises obtaining a spectrum for each of the plurality of angles of incidence on the basis of the infrared beam. Additionally the method comprises determining a quantitative measure of the material characteristic on the basis of the spectrum of each of the plurality of angles of incidence.

One illustrative measurement system disclosed herein is configured for determining material characteristics during semiconductor production. The system comprises a substrate holder configured to receive and hold in position a substrate having formed thereon one or more material layers that are usable for fabricating semiconductor devices. The system further comprises a radiation source configured to provide an infrared beam including a plurality of wavelength components. Additionally, the measurement system comprises a scan unit operatively connected to at least one of the substrate holder and the radiation source and configured to establish a plurality of different angles of incidence of the infrared beam. Moreover, the measurement system comprises a detector unit positioned to receive the infrared beam after interaction with the one or more material layers. Finally, the measurement system comprises a Fourier transformation unit connected to the detector unit and configured to provide a spectrum for each of the plurality of different angles of incidence.

### BRIEF DESCRIPTION OF THE DRAWINGS

The disclosure may be understood by reference to the following description taken in conjunction with the accompanying drawings, in which like reference numerals identify like elements, and in which:

FIG. 1a schematically illustrates a cross-sectional view of a semiconductor device having formed thereon one or more dielectric material layers whose layer thickness is to be determined in line on the basis of conventional optical measurement techniques;

FIG. 1b schematically illustrates the conventional semiconductor device with a patterned dielectric material for a metallization system wherein a degree of material modification in the dielectric material, such as a low-k dielectric material, may be determined on the basis of external destructive analysis techniques;

FIG. 1c schematically illustrates the semiconductor device during a sophisticated non-destructive measurement process on the basis of FTIR procedures based on a constant angle of incidence, according to conventional strategies;

FIG. 2a schematically illustrates a microstructure device including a dielectric layer or layer system, possibly having a specific surface topography during a measurement process on the basis of FTIR on a reflective operating mode with varying angles of incidence in order to enhance extraction of topography-related information and/or increasing “sensitivity” of the FTIR technique with respect to one or more material characteristics, according to illustrative embodiments;

FIG. 2b schematically illustrates the microstructure device during an FTIR measurement process based on a plurality of angles of incidence in a transmissive mode, according to illustrative embodiments; and

FIG. 2c schematically illustrates a measurement system for determining structural material characteristics on the basis of FTIR techniques based on various angles of incidence, according to further illustrative embodiments.

While the subject matter disclosed herein is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Various illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present subject matter will now be described with reference to the attached figures. Various structures, systems and devices are schematically depicted in the drawings for purposes of explanation only and so as to not obscure the present disclosure with details that are well known to those skilled in the art. Nevertheless, the attached drawings are included to describe and explain illustrative examples of the present disclosure. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

Generally, the present disclosure relates to methods and systems that enable a more efficient monitoring and, if desired, controlling of manufacturing processes on the basis of a determination of characteristics of materials, which may be formed and/or treated during a specific sequence of manufacturing processes during the fabrication of microstructure devices, such as sophisticated semiconductor devices. To this end, a measurement technique on the basis of the non-destructive FTIR concept may used, in which, as previously explained, structural material characteristics, i.e., characteristics depending on the chemical bonds between various species of the material, may be efficiently detected in a quantitative and qualitative manner by using an interference-modulated infrared beam in combination with Fourier transformation techniques so as to obtain corresponding measurement spectra within a moderately short measurement time with a high signal-to-noise ratio. To this end, the measurement may be performed on the basis of two or more angles of incidence of the probing infrared beam in order to obtain associated spectra, which may include the response of the material or material system under consideration to the various angles of incidence, which may allow the extraction of topography-related information, if a patterned material is considered and at least some wavelength components of the probing infrared beam are of comparable dimension with respect to the dimensions of features in the topography, while, in other cases, additionally or alternatively to the topography-related information, an increased amount of measurement data may be provided, which may then enable a more efficient extraction of information about material characteristics. That is, even if critical dimensions of device features are well below the wavelength of the various components of the probing infrared beam, the response of the “non-resolved” topography may nevertheless significantly change for different angles of incidence, for example, with respect to the “background” in the spectra caused by other material layers and the like, so that well-established data reduction techniques may be efficiently applied to the various measurement data, thereby providing enhanced reliability of the corresponding quantitative evaluations of one or more material characteristics. For example, although device features have critical dimensions of several nanometers, as may be encountered in sophisticated semiconductor devices, the response of a corresponding material layer, which may be seen by the probing infrared beam as a more or less featureless and continuous material, may differ for different angles of incidence since, for instance, the effective “optical length” on a non-resolved material layer may be increased, which may result in a different degree of interaction with the incoming and reflected infrared beam. In other cases, the increase of the effective optical length of certain device features may result in a “shift” of the optical resolution capability of the probing infrared beam, at least for some wavelength components, thereby providing even topography-related information, at least in a certain wavelength range of the resulting spectra. In other cases, when at least some of the device features may have dimensions that are comparable with the wavelength of at least some of the radiation components of the probing infrared beam, the variation of the angle of incidence may provide position-dependent information on specific material characteristics, such as composition of materials, the condition of chemical bonds thereof and the like. For example, as previously explained, a plurality of different dielectric materials may typically have to be used in the form of permanent materials of a semiconductor device, in the form of sacrificial layers, for instance in the form of polymer materials, resist materials and the like, wherein the composition of these dielectric materials may change during the manufacturing sequence, for instance upon patterning these materials, wherein a more or less gradual change of the material characteristics may be considered as a quantitative measure of the quality of the manufacturing processes involved, for instance, if sacrificial materials are considered, while, in the case of permanent materials, in addition to the monitoring of the process quality, the characteristics and performance of the finished microstructure devices may also be evaluated on the basis of these materials. The characteristics of dielectric materials may be substantially determined by the chemical composition, i.e., the presence of certain atomic species and the chemical bonds established within the material, so that many types of reaction with the environment, such as chemical interaction, mechanical stress, optical interaction, heat treatments and the like, may result in the modification of the molecular structure, for instance by re-arranging chemical bonds, breaking up chemical bonds, introducing additional atomic species in a more or less pronounced degree and the like. Consequently, the status of the one or more materials under consideration may, therefore, represent the accumulated history of the processes involved, thereby enabling efficient monitoring and, if desired, efficient control of at least some of the involved manufacturing processes. The structural information, i.e., the information represented by the molecular structure of the materials under consideration, may at least be partially made available to observation by FTIR techniques performed on the basis of varying angles of incidence, thereby obtaining associated spectra that contain the information about the chemical bonds and thus structure of the materials of interest. This information may further contain encoded therein specific topography-related information, depending on the overall dimensions of the features and/or may be “modulated” by the different angles of incidence, for instance with respect to signal-to-noise ratio and the like, so that a quantitative estimation of one or more material characteristics of interest may be accomplished in a more efficient manner compared to conventional FTIR strategies based on a single angle of incidence. For instance, in some illustrative embodiments, an appropriate set of measurement parameters, i.e., of wavelength components of the probing infrared beam in combination with one or more appropriate angles of incidence, may be determined on the basis of efficient data reduction techniques, such as principle component analysis (PCA), partial least square analysis (PLS) and the like, which may thus enable the identification of appropriate wavelengths or wave numbers, angles of incidence, which may convey most of the required information with respect to the structural characteristics of the one or more materials under consideration. Consequently, these efficient statistical data processing algorithms may not only be used to obtain a significant reduction of the high dimensional parameter space, i.e., the large number of wavelengths involved, without substantially losing valuable information on the intrinsic characteristics of the materials, but may also allow the selection of enhanced measurement “conditions” in the form of an appropriate angle of incidence, while, in other cases, even additional topography-related information may be obtained, as previously explained. For example, a powerful tool for evaluating a large number of measurement data, such as the intensities versus wave numbers of spectra, is the principle component analysis which may be used for efficient data reduction in order to establish an appropriate “model” on the basis of a reduced number of wavelengths or wave numbers. During the principle component analysis, the wave numbers of wave length may be identified, which may be correlated with a high degree of variability with respect to appropriate reference data, such as other measurement spectra or measurement data provided by other measurement techniques, in order to provide the reference data for the one or more material characteristics under consideration. For instance, in some illustrative embodiments, the measurement spectra obtained for a plurality of angles of incidence may be combined and may act as reference data, which may be “compared” with measurement data associated with individual angles of incidence, which may have been identified as measurement spectra providing a high degree of sensitivity with respect to the material characteristic under consideration. For this purpose, the data reduction techniques may efficiently enable the identification of wave numbers and angles of incidence that may contribute mostly to the structural characteristics of interests.

Similarly, powerful statistical analysis tools, such as PLS, may also be applied in combination with the FTIR techniques using a plurality of angles of incidence in order to identify representative portions of a spectrum and provide an appropriate regression model based on appropriate reference data, such as the combination of spectra associated with a plurality of angles of incidence, thereby also enabling efficient monitoring and/or controlling of processes on the basis of a non-destructive measurement technique. In still other illustrative embodiments, other analysis techniques such as CLS (classical least square) regression may be applied in which reference spectra, such as the spectra associated with different angles of incidence and spectra associated with different materials, may be combined to provide an appropriate model or reference, which may then be used for evaluating even subtle changes of material systems under consideration, wherein topography-related information may be contained in a more or less pronounced manner.

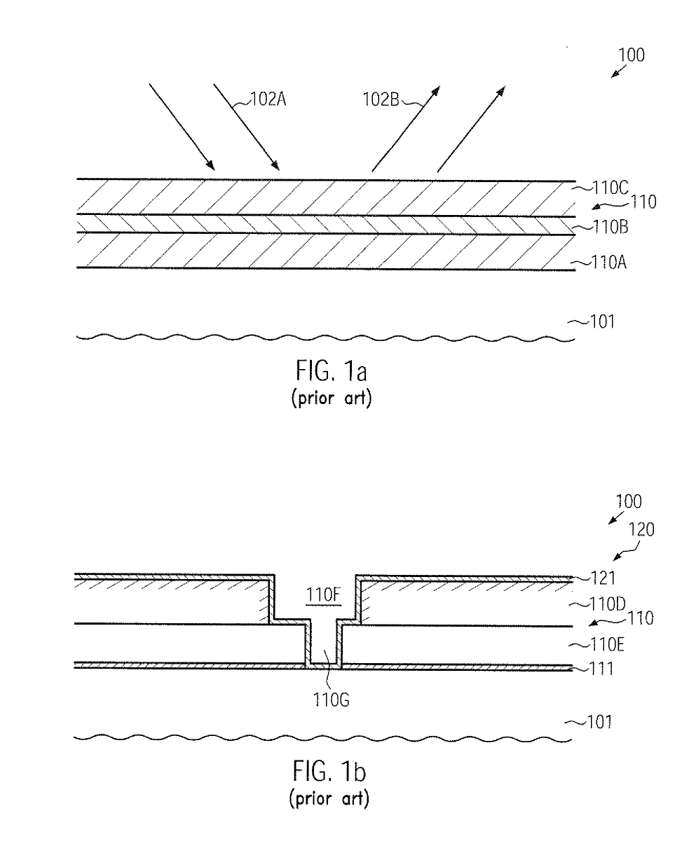

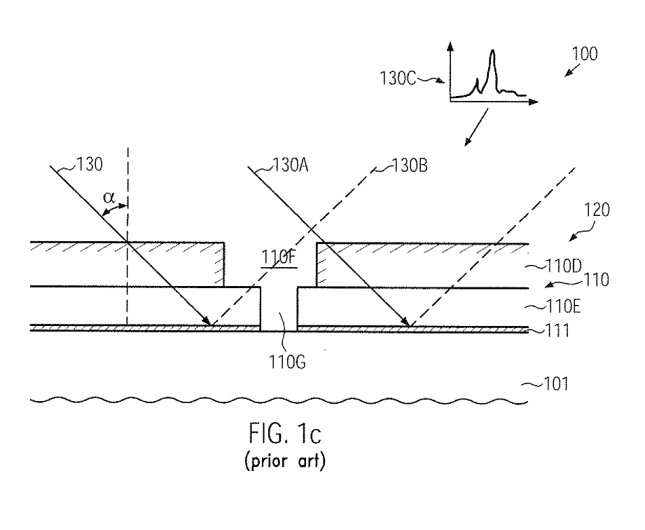

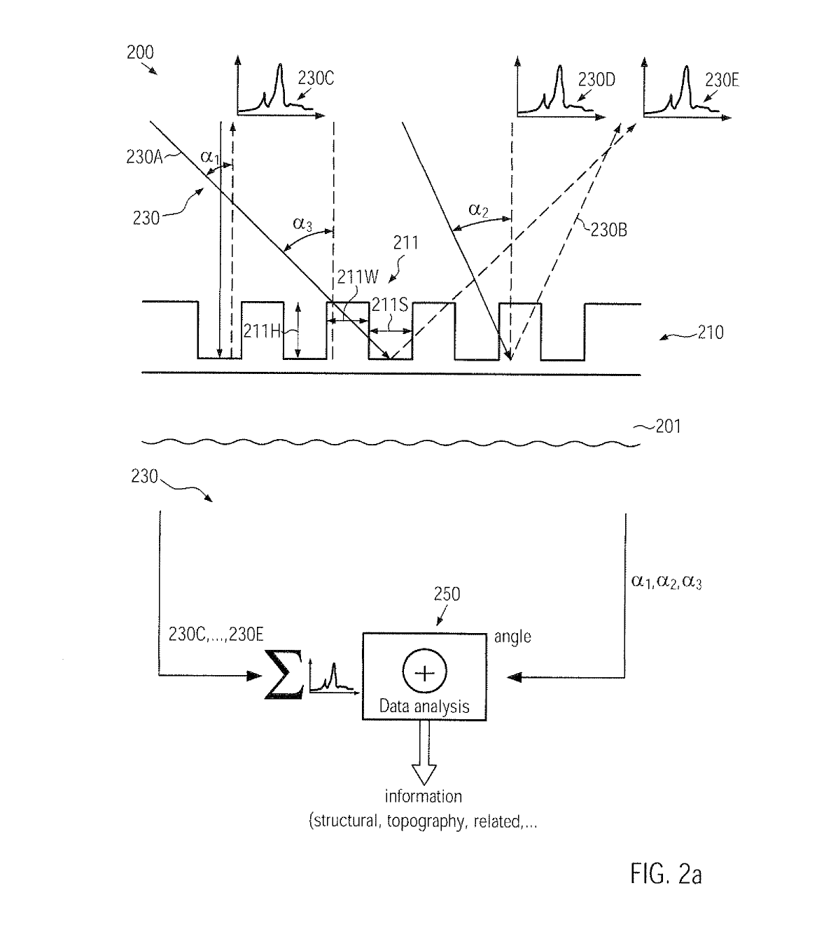

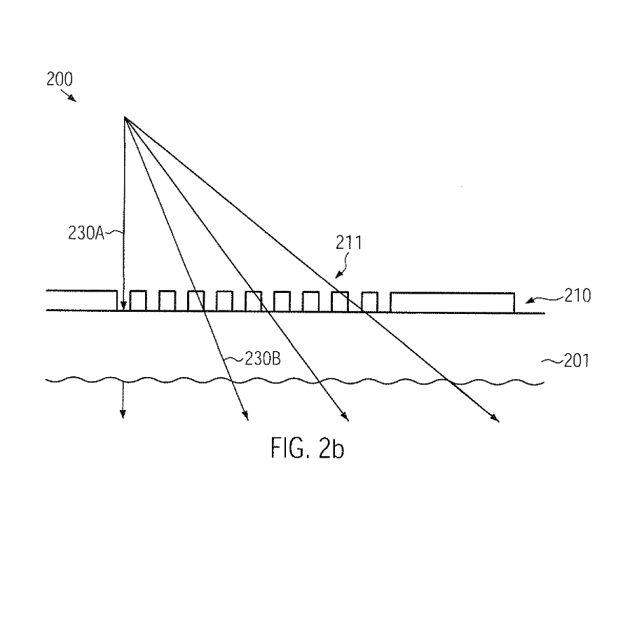

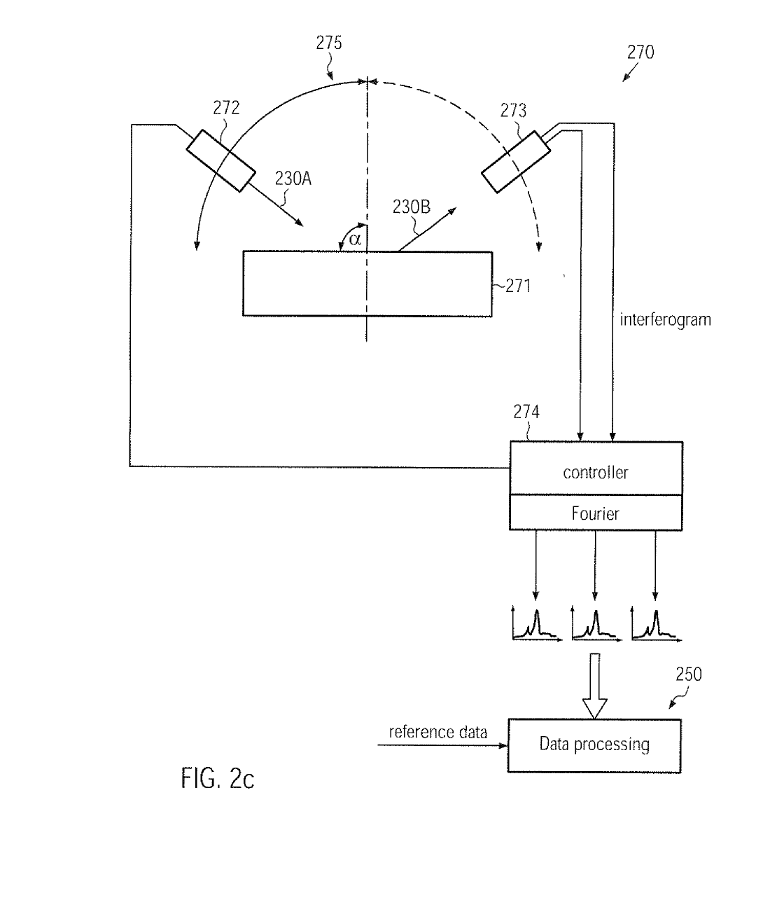

With reference to FIGS. 2a-2c, further illustrative embodiments will now be described in more detail, wherein reference may also be made to FIGS. 1a-1c, if appropriate.

FIG. 2a schematically illustrates a cross-sectional view of a semiconductor device 200 during an FTIR measurement process 230 performed on the basis of a plurality of angles of incidence. In the manufacturing stage shown in FIG. 2a, the semiconductor device 200 may comprise a substrate 201 that represents any appropriate carrier material for forming therein and thereon circuit elements, micromechanical components, opto electronic components and the like. For example, the substrate 201 may comprise an appropriate base material, such as any appropriate semiconductor material, an insulating material and the like, above which may be formed a semiconductor layer, such as a silicon-based layer, a germanium layer, a compound semiconductor layer having incorporated therein any appropriate species for obtaining the desired electronic characteristics and the like. For convenience, any such semiconductor layer is not explicitly shown in FIG. 2a. Furthermore, the semiconductor device 200 may comprise one or more materials 210, such as dielectric materials having a reduced dielectric constant and the like, whose characteristic may be evaluated in a quantitative manner, as will be explained later on or as is described above. In other cases, the one or more materials 210 may comprise any dielectric material, such as resist material, polymer material and the like, which may be required, at least temporarily, for the further processing of the device 200. In the embodiment shown, at least a portion of the one or more materials 210 may comprise a patterned portion 211, which may be understood as a device region including device features, such as lines and spaces and the like, thereby resulting in a pronounced surface topography. Thus, the patterned structure or the device features 211 define a plurality of topography-specific dimensions, such as a height 211H, a first width 211W and a second width 211S. For instance, features 211 may represent resist features used as implantation masks, etch masks and the like, while, in other cases, the features 211 may represent trenches and other recesses which may be filled in a subsequent manufacturing process, as is, for instance, described above with reference to the semiconductor device 100 when referring to the metallization system 120 (FIGS. 1b-1c). Consequently, in sophisticated applications, at least many of the device features 211 may have dimensions that are in the range of several hundred nanometers and significantly less, such as 50 nm and less, which may be significantly smaller compared to the wavelength used during the measurement process 230. In other cases, at least some of the device features 211 may have at least one dimension that is comparable or greater than the wavelength of one or more of the radiation components used in the measurement process 230.

It should be appreciated that the semiconductor device 200 may be formed on the basis of any appropriate process technique which, for instance, may include process steps as previously described in conjunction with the semiconductor device 100 when, for instance, referring to a metallization system and corresponding dielectric material used therein. It should be appreciated that the portion of the semiconductor device 200 illustrated in FIG. 2a and subjected to the FTIR measurement process 230 may represent a dedicated test substrate in which appropriate measurement conditions may be established by, for instance, providing an appropriate substrate and base material 201 in combination with the patterned material layer 210, while, in other cases, the portion shown in FIG. 2a may be provided in dedicated test areas of a product substrate when resulting measurement conditions are compatible with the overall configuration of the manufacturing stage and material composition of the device 200. For instance, in the embodiment shown in FIG. 2a, the FTIR measurement 230 may be performed in a “reflection mode,” that is, an incoming probing beam 230A, which may contain a plurality of infrared wavelength components, as previously explained, may be reflected by the substrate 201 or any appropriate layer or layer stack formed thereabove, in order to produce a reflected beam 230B, wherein both the probing beam 230A and the reflective beam 230B may interact with the material layer 210 and thus with the device features 211. That is, within the material layer 210 or within the substrate 201 an appropriate interface may be provided, which may result in a high degree of reflection for the wavelength range contained in the probing beam 230A, wherein a certain degree of absorption may occur due to the excitement of specific rotational and vibrational states in the material 210, which may thus indicate the present state of the material 210 including the device features 211. Furthermore, as illustrated, during the measurement process 230, the probing beam 230A may be directed onto the material layer 210 under different angles of incidence, indicated as α1, α2, α3, thereby obtaining different responses of the material 210 in the form of the reflected beams 230B, which may thus represent corresponding interferograms including the structural and possibly the topography-related information, which may be represented in the form of Fourier transformed data sets, i.e., spectra 230C, 230D, 230E. For instance, the angles of incidence α1, α2, α3 may be varied from the range of approximately 0, that is, substantially perpendicular, to approximately 80 degrees and higher, depending on the overall optical characteristics of the material 210 and the features 211. In the case that feature sizes, such as 211W and 211S, are comparable or greater than at least some of the wavelength components of the beams 230A, 230B, the spectra 230C, 230D, 230E may contain, in addition to structural information, i.e., information on chemical bonds and the like, also topography-related information since, depending on the angle of incidence, surface areas, sidewall areas, bottom areas, may preferably be probed by the beam 230A, 230B and may contain information about the chemical composition of materials in these areas of the pattern structure 211, depending on the angle of incidence. Consequently, based on the spectra 230C, 230D, 230E obtained on the basis of the different angles of incidence, the variability in the spectra may be correlated with the angles of incidence. For instance, as illustrated in FIG. 2a, the measurement data in the form of the spectra 230C, 230D, 230E or in any other appropriate form may be supplied to a data analysis unit 250, which may also receive the corresponding angles of incidence in order to extract the desired information from these data. For instance, the data analysis unit 250 may combine the spectra 230C, 230D, 230E so as to obtain an integral or reference data set, which may thus be compared with the individual spectra in order to associate the quantitative values for a certain material characteristic with topography-related information. For instance, under the condition of an appropriate size of the features 211, a moderately great angle of incidence may provide information preferably with respect to sidewall areas and top surfaces of the features 211, while a small angle of incidence may preferably probe top surface areas and bottom areas of the features 211. Consequently, if a cap material may be formed on the features 211, respective contributions of such a cap material may be more efficiently obtained by selecting appropriate angles of incidence and associated spectra. In this case, the knowledge of the angle of incidence may be taken advantage of by correlating certain spectra or portions thereof with a corresponding material characteristic at certain areas of the features 211. It should be appreciated that the data analysis unit 250 may have implemented therein any appropriate algorithms, such as explained above, in order to extract the desired information from the measurement spectra. For instance, reference data may be obtained on the basis of measurements with the material 210 of well-known condition, wherein the knowledge may be obtained by other measurement techniques, such as cross-sectional analysis and the like. In this case, the measurement spectra may be appropriately “normalized” with respect to the reference data or vice versa and the corresponding spectra may be subtracted and may then be further analyzed in view of evaluating one or more material characteristics under consideration. In other illustrative embodiments, as previously explained, a data reduction may be performed on the basis of the spectra 230C, 230D, 230E, for instance using any of the above-described established statistical analysis techniques in order to identify prominent wavelength components, which may convey the major part of the information of interest. In some illustrative embodiments, after identifying respective wavelength components or wavelength ranges within the spectra 230C, 230D, 230E, the measurement 230, i.e., the provision of the beam 230A, may be substantially restricted to the wavelength components or wavelength range of interest, thereby even further reducing the overall measurement time and increasing the overall signal-to-noise ratio.

Thus, upon analyzing the data in the unit 250, the desired information, such as a thickness of the damaged zone of a dielectric material, as previously explained with reference to FIGS. 1b-1c, the presence of different materials, the variation of a layer thickness of these materials and the like, may be obtained, possibly in combination with topographyrelated information, depending on the overall feature sizes. In other cases, the wavelength of each radiation component of the probing beam 230A may be greater than any of the feature sizes of the features 211 so that a corresponding spectrum may represent an integral “overview” of the features 211 and the corresponding chemical characteristics thereof. However, also in this case, the employment of the different angles of incidence may provide additional information or enhanced efficiency in extracting information from the spectra 230C, 230D, 230E. For example, by varying the angle of incidence, the effective optical thickness of the patterned structure 211 may be varied, even though the structure 211 may be “seen” by the probing beam 230A as a “continuous” material layer, the characteristics of which are a combination of the characteristics of the individual structural components, such as lines and spaces including various materials and the like. Consequently, by varying the effective optical path lengths of the probing beam 230A and also of the reflected beam 230B, the composition of the spectra 230C, 230D, 230E may also vary, in particular if the overall size of the beam 230A may be less than an overall size of the patterned structure 211. Consequently, although each of the spectra 230C, 230D, 230E may provide an integral representation of the structure 211, the signal-to-noise ratio and the like may differ for the various angles of incidence and thus the unit 250 may identify one or more angles of incidence and associated spectra, which may provide a superior variability with respect to a material characteristic of interest. In one illustrative embodiment, the angle of incidence may be selected so as to obtain the maximum variability with respect to the material characteristic of interest, such as a thickness of a modified zone of a sensitive dielectric material, as previously explained, thereby enabling superior data analysis compared to conventional strategies in which a single angle of incidence is used in FTIR techniques. For example, the angle of incidence may be considered as a further measurement parameter, for instance, for a principal component analysis, and may thus be used for determining an appropriately selected parameter space of significantly reduced dimensions. Thus, in still other illustrative embodiments, maximum variability of a material characteristic of interest may be established on the basis of the various wavelength components of the probing beam 230A and on the basis of the angles of incidence in order to provide efficient data reduction. It should be appreciated that a pronounced degree of variability may occur with respect to the angles of incidence in the resulting spectra in cases in which a variation of the effective optical length of the patterned structure 211 may result in a corresponding “increase” of the effective dimensions of the features 211 so as to come within a size that is comparable with at least some of the wavelengths contained in the probing beam 230A. Hence, in this case, a pronounced variability may be expected, at least for the range of the shortest wavelength within the spectra associated with a corresponding great angle of incidence.

FIG. 2b schematically illustrates the semiconductor device 200 during the FTIR measurement 230 based on a plurality of angles of incidence in a “transmissive” mode. That is, the probing beam 230A may pass through the substrate 201 after interacting with the one or more materials 210 and the patterned structure 211 and may be detected as a transmitted beam 230B by a corresponding detector. In this case, the substrate 201 may be appropriately adapted so as to be substantially “transparent” for the beam 230A, which is the case for a plurality of semiconductor materials, such as silicon and the like. Also, in the transmissive operating mode of the measurement process 230, the same data analysis techniques may be applied as discussed above with reference to FIG. 2a. Consequently, also in this mode, superior data analysis efficiency and/or increased information with respect to the material characteristics under consideration may be obtained.

FIG. 2c schematically illustrates a measurement system 270 as may be used for the measurement 230 previously described with reference to FIGS. 2a-2b. The system 270 may comprise a substrate holder 271 that is appropriately configured to receive and hold in place a substrate, such as the substrate 201 as previously described. Furthermore, an infrared radiation source 272 and an infrared detecting system 273 may be provided in combination with a scan system 275, which may be appropriately configured to enable a variation of the angle of incidence of a probing beam 230A and to enable the detection of the corresponding reflected or transmitted beam 230B. For example, the scan system 275 may include any mechanical and other components (not shown) for appropriately positioning the radiation source 272 and the detector 273 with respect to the substrate holder 271 so as to adjust a desired angle of incidence for a dedicated run of a corresponding measurement process. Moreover, the system 270 may comprise a controller 274 that may be operatively connected to the radiation source 272, the detector 273 and the scan unit 275. In this case, the controller 274 may appropriately control the angle of incidence and obtain an appropriate interferogram from the detector 273 associated with the currently used angle of incidence. Moreover, the controller 274 may further be configured to perform a Fourier transformation in order to provide respective measurement spectra for each of a plurality of angles of incidence. For this purpose, any appropriate Fourier transformation algorithm may be implemented into the control 274.

Thus, upon operating the system 270, the probing beam 230A may be directed to the substrate holder 271 having positioned thereon a substrate, such as a dedicated test wafer, a product substrate including test areas and the like, in order to obtain a desired interaction with a material or material system of interest. The reflected or transmitted beam 230B may be received by the detector 273 and may be transferred to the controller 274 for a given angle of incidence. Thereafter, a further angle of incidence may be selected in order to obtain a further interferogram and a corresponding measurement spectrum.

It should be appreciated that, in the embodiment shown in FIG. 2c, the different angles of incidence may be obtained on the basis of the scan system 275, which may provide for relative motion between the substrate holder 271 and the radiation source 272 and the detector 273. In other illustrative embodiments, the scan system 275 may represent a “stationary” system in which two or more radiation sources 272 and appropriately positioned detectors 273 may be provided so as to realize two or more angles of incidence. In this case, the overall measurement time may be reduced since the time interval required for a relative motion may be avoided, while, in other cases, still a substantially simultaneous measurement for two or more angles of incidence may be accomplished, for instance by appropriately restricting the apertures of the various detectors 273. Hence, in this case, a plurality of spectra may be obtained in a time interval that is comparable to conventional FTIR measurement based on a single angle of incidence.

Furthermore, as illustrated in FIG. 2c, the system 270 may comprise the data processing or analysis unit 250, which may provide the desired information, as explained above, on the basis of the measurement spectra provided by the controller 274. In some illustrative embodiments, as previously discussed, the data analysis unit 250 may receive “external” reference data which may be obtained on the basis of different measurement techniques, such as electron microscopy, x-ray analysis and the like. In other cases, reference data may be obtained on the basis of the measurement data itself, as is also discussed above.

As a result, the present disclosure provides measurement techniques on the basis of FTIR procedures and corresponding systems in which a plurality of angles of incidence may be used for enhancing efficiency and/or the amount of information obtained from a patterned dielectric material or material system.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method, comprising:
obtaining a first measurement data set by performing a first run of a Fourier transformed infrared spectroscopy (FTIR) measurement using a first probing beam directed on a substrate under a first angle of incidence, said substrate comprising a material layer used for forming a microstructure device;
obtaining a second measurement data set from said substrate by performing a second run of said FTIR measurement using a second probing beam directed on said substrate under a second angle of incidence that differs from said first angle of incidence; and
determining at least one structural characteristic of said material layer on the basis of said first and second measurement data sets.

2. The method of claim 1, wherein said material layer comprises a surface topography defining a first critical dimension that corresponds to a second critical dimension of device features of said microstructure device.

3. The method of claim 1, wherein determining said at least one structural characteristic comprises identifying a relevant portion in at least one of said first and second measurement data sets that has a maximum correlation to said at least one structural characteristic.

4. The method of claim 3, wherein identifying said relevant portion in at least one of said first and second measurement data sets comprises generating a reference data set from at least one of said first and second measurement data sets and comparing at least one of said first and second measurement data sets with said reference data set.

5. The method of claim 1, wherein said material layer comprises a low-k dielectric material acting as an interlayer dielectric material of a metallization system of said microstructure device.

6. The method of claim 1, wherein obtaining said first and second measurement data sets comprises detecting a portion of said probing beam that passes through said material layer and said substrate.

7. The method of claim 1, wherein obtaining said first and second measurement data sets comprises detecting a portion of said probing beam that is reflected from above said substrate.

8. The method of claim 1, wherein determining said at least one structural characteristic comprises applying at least one of a partial least square technique, a principal component analysis technique and a classical least square technique to said first measurement data set.

9. The method of claim 1, wherein determining said at least one structural characteristic comprises obtaining a reference data set from said material layer by using a non-FTIR measurement technique.

10. The method of claim 9, further comprising performing a data reduction on said first and second measurement data sets so as to identify appropriate representatives of a subset of wavelengths used in said probing beam, wherein said representatives represent said at least one structural characteristic.

11. The method of claim 2, wherein said second critical dimension is less than a minimum wavelength used in said probing beam.

12. The method of claim 2, further comprising determining a correlation between said first and second angles of incidence and a first and second characteristic of said at least one structural characteristic.

13. The method of claim 12, further comprising performing an FTIR measurement on a plurality of further substrates using said one of said first and second angles of incidence and said correlation so as to monitor one of said first and second characteristics that is associated with said one of said first and second angles of incidence.

14. A method of monitoring a material characteristic of one or more material layers in a semiconductor manufacturing process sequence, the method comprising:
probing said one or more material layers with an infrared beam at a plurality of angles of incidence, said infrared beam including a plurality of wavelengths;
obtaining a spectrum for each of said plurality of angles of incidence on the basis of said infrared beam; and
determining a quantitative measure of said material characteristic on the basis of said spectrum of each of said plurality of angles of incidence.

15. The method of claim 14, wherein at least one of said one or more material layers is patterned so as to form a surface topography defining lateral dimensions of features of a semiconductor device.

16. The method of claim 15, wherein at least some of said lateral dimensions are less than one or more of said wavelengths of said infrared beam.

17. The method of claim 15, further comprising determining a specific angle of incidence resulting in a maximum variability of the spectrum associated with said specific angle of incidence.

18. The method of claim 17, further comprising determining said specific angle of incidence on the basis of geometrical characteristic of said surface topography.

19. The method of claim 17, wherein determining said specific angle of incidence comprises providing reference data indicating a quantitative measure of said material characteristic.

20. The method of claim 14, wherein said semiconductor manufacturing process sequence comprises forming a metallization system of semiconductor devices on the basis of said one or more material layers.

21. The method of claim 20, wherein said one or more material layers comprises a low-k dielectric material.

22. A measurement system for determining material characteristics during semiconductor production, the system comprising:
a substrate holder configured to receive and hold in position a substrate having formed thereon one or more material layers usable for fabricating semiconductor devices;
a radiation source configured to provide an infrared beam including a plurality of wavelength components;
a scan unit operatively connected to at least one of said substrate holder and said radiation source and configured to establish a plurality of different angles of incidence of said infrared beam;
a detector unit positioned to receive said infrared beam after interaction with said one or more material layers; and
a Fourier transformation unit connected to said detector unit and configured to provide a spectrum for each of said plurality of different angles of incidence.
